(19) United States
(12) Patent Application Publication
(10) Pub. No.: US 2012/0231250 A1
(43) Pub. Date: Sep. 13, 2012

(54) COMPOSITION FOR ORAL CAVITY, CHEWING GUM AND ORAL REFRESHING CANDY

(75) Inventors: Machiko Minatoya, Tokyo (JP); Seiichiro Tabata, Kanagawa (JP); Hironori Iida, Kanagawa (JP); Shun Yamanoi, Kanagawa (JP); Shinichiro Yamada, Kanagawa (JP)

(73) Assignee: Sony Corporation, Tokyo (JP)

(21) Appl. No.: 13/411,020

(22) Filed: Mar. 2, 2012

(30) Foreign Application Priority Data
Mar. 11, 2011 (JP) 2011-054444

(51) Int. Cl. B32B 3/00

(52) U.S. Cl. 428/219

(57) ABSTRACT

Provided is a composition for oral cavity comprising a porous carbon material having a specific surface area of 10 m²/g or more according to a nitrogen BET method, and a volume of a pore of 0.1 cm³/g or more according to a BJH method.

### BACKGROUND

The present disclosure relates to a composition for oral cavity, a chewing gum and oral refreshing candies, and more particularly to a composition for oral cavity having an anti-dental caries effect, an anti-periodontal disease effect, or an anti-halitosis effect, and a chewing gum and oral refreshing candies including a material forming the composition for oral cavity.

Caries bacteria adhere to a surface of a tooth to form dental plaque, whereby dental caries is initiated. In the dental plaque, the caries bacteria metabolize foods to generate an acid, and the acid decalcifies dental enamel, thus resulting in an initial stage of dental caries.

In a variety of intraoral diseases such as dental caries, periodontal disease and halitosis, for example, the dental caries is caused by mutans streptococci including Streptococcus mutans; the periodontal disease is caused by Porphyromonas gingivalis; and the halitosis is caused by anaerobic gram-negative bacilli such as Fusobacterium nucleatum. Suppression of the growth or the biofilm formation of these bacteria is, accordingly, useful for oral disease prophylaxis, and bacteriocides and antibacterial agents have hitherto been used as a way to suppress them.

Dentifrices including a component of activated carbon or a charcoal powder are known (for example, see Japanese Patent Application Laid-open No. HEI 05-105616 and Japanese Patent Application Laid-open No. HEI 10-95721, which are hereinafter referred to as Patent Document 1 and Patent Document 2, respectively). In addition, for example, a method for suppressing dental caries using Streptococcus salivarius (see Japanese Patent Application Laid-open No. HEI 05-004927, which is hereinafter referred to as Patent Document 3); a method for preventing dental caries in which proliferation of S. mutans is suppressed by using Lactobacillus reuteri (see Japanese Patent Application Laid-open No. 2003-299480, which is hereinafter referred to as Patent Document 4), a method using both Lactobacillus and Streptococcus (Japanese Patent Application Laid-open No. 2006-262893, hereinafter referred to as Patent Document 5) are proposed. Further, Japanese Patent Application Laid-open No. SHO 49-006161 (hereinafter referred to as Patent Document 6) discloses a chewing gum including a caries bacterial cell-lytic enzyme.

### SUMMARY

The known dentifrices disclosed in Patent Documents 1 and 2 are expected to have an effect of polishing dental enamel, prevention of tooth decay and adsorption and removal of oral microorganisms or remains of a meal by inclusion of the activated carbon or the charcoal powder. These effects, however, are not clearly known yet as far as the present inventors know from their investigations. In addition, all of the methods disclosed in Patent Document 3, Patent Document 4 and Patent Document 5 only focus on an effect of eliminating pathogens and the like, but they do not describe a risk for newly generating dental caries which may be possibly generated by an acid generated by the microbial administrated. An enzyme included in the chewing gum disclosed in Patent Document 6 includes a protein or glycoprotein, which is thermally unstable. In particular, because a production method of a chewing gum has a step of heating, melting and mixing materials, the enzyme is easily deactivated, and therefore it is difficult to maintain the enzyme activity. Oral refreshing candies have the same problems as described above. In addition, commercial dentifrices are formed from various components. In order to prevent tooth decay, a fluoride (fluorine) is used, and a cationic surfactant is used as a disinfectant. These chemical components, however, remain in a mouth after the use, and they may sometimes exert bad influences. The development of dentifrices capable of safely using for a long term, accordingly, is expected.

It is said that oxygen in the body, in particular, reactive oxygen species such as superoxide radicals, hydroxy radicals, hydrogen peroxide and singlet oxygen have toxicity harmful to biological tissues, and they are drawing attention as one of the important causes inducing various diseases including skin aging or cancer, stroke and rheumatism. Then interest in a composition for oral cavity, foods and beverages having ability of eliminating the reactive oxygen has increased. Also, an increase in allergic symptoms caused by rapid change of social environment and appearance of chemical foods becomes a big social problem. Although the reactive oxygen species cause damage to human bodies as described above, the human bodies have a mechanism of preventing damage of biotissues or organs caused by the reactive oxygen species. For example, an eliminating effect (antioxidative effect) of the reactive oxygen species themselves by an enzyme such as superoxide dimustase (hereinafter referred to as “SOD”) or catalase falls under the mechanism described above. The expression level of the enzyme, however, is suddenly decreased with aging, and therefore damages caused by the reactive oxygen species are increased, and the disease and injury associated therewith remarkably often. In addition, an increased exposure to ultraviolet rays and a condition in which chemical substances such as exhaust gas and cigarettes are spread in the air in the contemporary living environment interfere with the sufficient exhibition of a self-defense mechanism against excessive generation of reactive oxygen species even in the young, and the occurrence of injury and disease is increased. Further, it has been reported that the reactive oxygen species, which induce oxidative stress, are involved in periodontal disease, and dentistry also focuses on the antioxidative effect. Providing the antioxidative effect to a composition for oral cavity, a chewing gum and oral refreshing candies, accordingly, is extremely desirable.

In the present disclose, it is desirable to provide a composition for oral cavity having a polishing effect and capable of preventing tooth decay, and adsorbing or removing oral microorganisms and remains of a meal, and having no risk for newly generating dental caries, and capable of safely using for a long term, and a chewing gum and an oral refreshing candy including a material forming the composition for oral cavity; or a composition for oral cavity having an antioxidative effect, and a chewing gum and an oral refreshing candy including a material forming the composition for oral cavity.

According to a first mode of this disclosure for attaining the aim described above, the composition for oral cavity includes a porous carbon material having a specific surface area of 10 m²/g or more according to a nitrogen BET method, and a volume of a pore of 0.1 cm³/g or more according to a BJH method. Such a porous carbon material may be sometimes referred to as a “porous carbon material according to the first mode of this disclose,” for convenience sake.

According to a second mode of this disclosure for attaining the aim described above, the composition for oral cavity includes a porous carbon material having a specific surface area of 10 m²/g or more according to a nitrogen BET method, and a sum of volumes of pores having a diameter of 1×10⁻⁹ m to 5×10⁻⁷ m of 0.1 cm³/g or more according to a nonlocal density functional theory method. Such a porous carbon material may be sometimes referred to as a “porous carbon material according to the second mode of this disclosure,” for convenience sake.

According to a third mode of this disclosure for attaining the aim described above, the composition for oral cavity includes a porous carbon material having a specific surface area of 10 m²/g or more according to a nitrogen BET method, at least one peak within a range of 3 nm to 20 nm in a pore size distribution determined by a nonlocal density functional theory method, and a ratio of a sum of volumes of pores having a pore size in a range of 3 nm to 20 nm of 0.2 or more based on a sum of volumes of all pores. Such a porous carbon material may be sometimes referred to as a “porous carbon material according to the third mode of this disclosure,” for convenience sake.

A chewing gum according to a first, second or third mode of this disclosure for attaining the aim described above includes the porous carbon material according to the first, second or third mode of this disclosure. In addition, an oral refreshing candy (a mouth refreshing candy) according to a first, second or third mode of this disclosure for attaining the aim described above includes the porous carbon material according to the first, second or third mode of this disclosure.

According to the first to third modes of this disclosure, in the porous carbon materials (hereinafter, the porous carbon materials according to the first to third modes of this disclosure, collectively, may be sometimes a “porous carbon materials in this disclosure”) included in the compositions for oral cavity, the value of the specific surface area and the values of a variety of the volumes of a pore are defined to specific values. Therefore, the anti-dental caries effect, the anti-periodontal disease effect and the anti-halitosis effect can be exhibited; polishing effect, prevention of tooth decay, and adsorption and removal of oral microorganisms and remains of a meal by a good adsorption effect of the porous carbon material can be realized; there is no risk for newly generating a dental caries; and the composition can be safely and effectively used for a long term because the composition is formed from the porous carbon material described above.

Further, in addition to the effects described above, the compositions for oral cavity according to the first to third modes of this disclosure not only can alkalize the inside of the mouth by natural minerals included in the porous carbon material, thus resulting in expectation of the prevention of tooth decay, but also the antioxidative effect can be exhibited. Namely, the composition can alkalize the mouth due to elution of a small amount of carbonates generated during a carbonization or activation process described below, or an elution condition of a mineral component generated by an increased ash content caused by increasing a degree of activation described below (which can be thought as a residual ash generated during a baking and activation process and contained in the surface or inside of the porous carbon material). In addition, it would appear that the antioxidative effect is generated based on a phenomenon in which functional groups on the surface of the porous carbon material, such as a ketone group or carboxyl group, provide electrons to an object.

The chewing gum and the oral refreshing candy according to the first to third modes of this disclosure include the porous carbon material according to the first to third modes of this disclosure, and therefore they have the same effects as those of the composition for oral cavity according to the first to third modes of this disclosure described above. Even if the production method of the chewing gum or the oral refreshing candies has a step of heating, melting and mixing the porous carbon material, the porous carbon material is thermally stable, and thus it is not change by heating or melting.

These and other objects, features and advantages of the present disclosure will become more apparent in light of the following detailed description of best mode embodiments thereof, as illustrated in the accompanying drawing.

### BRIEF DESCRIPTION OF DRAWINGS

FIG. 1 is a graph showing measurement results of a pore size distribution of a composition for oral cavity of Example 1, determined by a nonlocal density functional theory method.

### DETAIL DESCRIPTION OF EMBODIMENTS

Hereinafter, embodiments of the present disclosure will be described based on Examples, with reference to the drawing. The present disclosure, however, is not limited to Examples, and various numerals and materials in Examples are illustrative only. The explanation will be made in the following order.

1. General explanation of the composition for oral cavity, the chewing gum and the oral refreshing candy according to the first to third modes of this disclosure.
2. Example 1 (the composition for oral cavity, the chewing gum and the oral refreshing candy according to the first to third modes of this disclosure)
3. Example 2 (modification of Example 1) and others.
[General Explanation of Composition for Oral Cavity, Chewing Gum and Oral Refreshing Candies According to First to Third Modes Of this Disclosure]

In the chewing gum or the oral refreshing candy according to the first to third modes of this disclosure, the porous carbon material has desirably an average particle size of 1×10⁻⁷ m to 1×10⁻⁴ m, preferably 2×10⁻⁵ m to 3×10⁻⁵ m. In the chewing gum or the oral refreshing candy having the desired form according to the first to third modes of this disclosure, the porous carbon material is desirably included in a content of 0.01% by mass to 5% by mass, preferably 0.05% by mass to 3% by mass, more preferably 0.1% by mass to 1% by mass. When the average particle size of the porous carbon material is defined to be from 1×10⁻⁷ m to 1×10⁻⁴ m, there is no sense of roughness on the chewing gum or the oral refreshing candy, nor feeling of discomfort in food texture when the chewing gum or the oral refreshing candy is put into a mouth. When the addition content of the porous carbon material is defined to be from 0.01% by mass to 5% by mass, the anti-dental caries effect and the antioxidative effect can be sufficiently exhibited, and moreover, there is no problem in the feeling when it is put in a mouth, the appearance, and the production. The average particle size can be measured based on a particle size distribution measurement according to a laser diffraction scattering method.

A material derived from a plant can be used as a starting material of the porous carbon material in this disclosure. Here, examples of the material derived from a plant may include, but not limited to, chaff or straw of rice (rice plant), barley, wheat, rye, barnyard millet and foxtail millet; coffee beans, tea leaves (for example, leaves of green tea or tea), sugar canes (more specifically, pomace of sugar cone), corns (more specifically, corn cores), rinds of fruits (for example, rinds of an orange or banana), reed and wakame stem. In addition to these materials, the material may include, for example, tracheophytes growing on land, pteridophyte, bryophyte, algae and marine plants. These materials may be used alone or as a mixture of multiple kinds thereof as the starting material. The shape and morphology of the material derived from the plant are not particularly limited, and the material may be the chaff or straw as it is, or may be a dried product. Further, products which are subjected to various treatments such as fermentation, roasting and extraction in food and beverage processes of beer or foreign liquors may be used as the material. In particular, it is preferable to use the straw or chaff obtained after a processing such as threshing, in the terms of recycling of industrial wastes. The straw and chaff after processing can be easily obtained in a large amount from, for example, an agricultural cooperative association, a liquor manufacture, a food company or a food processing company.

When a starting material of the porous carbon material in this disclosure is a material derived from a plant and including silicon (Si), specifically, a material derived from a plant and having a silicon (Si) content of 5% by mass or more is used as the starting material of the porous carbon material, but the starting material is not limited thereto. The porous carbon material has desirably a silicon (Si) content of 5% by mass or less, preferably 3% by mass or less, more preferably 1% by mass or less.

The porous carbon material in this disclosure can be obtained, for example, by carbonizing a material derived from a plant at 400° C. to 1,400° C., and then treating it with an acid or alkali. In the production method of the porous carbon material in this disclosure (hereinafter, the above-mentioned production method may be sometimes referred to as just a “production method of the porous carbon material”), a material which is obtained by carbonizing a material derived from a plant at 400° C. to 1,400° C., but is not treated with an acid or alkali is referred to as a “porous carbon material precursor,” or a “carbonaceous material.”

In the production method of the porous carbon material, after the acid or alkali treatment, the activation treatment may be performed, or after the activation treatment, the acid or alkali treatment may be performed. In the production method of the porous carbon material including such a preferable embodiment, the material derived from a plant may be subjected to a heat treatment (pre-carbonization treatment) in which the material is heated at a temperature lower than the temperature for the carbonization (for example, 400° C. to 700° C.) under the condition of oxygen insulation prior to the carbonization of the material derived from the plant, though it depends on the material derived from the plant used. In this way, a tar component, which will be produced during the carbonization, can be extracted, thus resulting in decrease or removal of the tar component which will be produced during the carbonization. The condition of oxygen insulation can be obtained by adopting an atmosphere with inert gas such as nitrogen gas or argon gas, evacuating the atmosphere, or by, a kind of, steaming and baking of the material derived from a plant. In the production method of the porous carbon material, in order to decrease a content of a mineral component or water included in the material derived from a plant, or prevent generation of bad smell during the carbonization, the material derived from a plant may be immersed in an alcohol such as methyl alcohol, ethyl alcohol or isopropyl alcohol, though it depends on the material derived from a plant used. In the production method of the porous carbon material, the pre-carbonization treatment may be performed after that. Preferable examples of the material which is subjected to the heat treatment in an inert gas may include, for example, plants which generate a large amount of wood vinegar (tar and light oil component). Preferable examples of the material which is pre-treated with the alcohol may include, for example, marine plants having a large amount of iodine or various minerals.

In the production method of the porous carbon material, the material derived from a plant is carbonized at 400° C. to 1,400° C. Here, the term “carbonization” generally refers to a conversion of an organic substance (the material derived from a plant in the case of the porous carbon material in this disclosure) into a carbonaceous material by heat treatment (see, for example, JIS M 0104-1984). As the atmosphere for the carbonization, an atmosphere of oxygen insulation may be exemplified, and specifically, the atmosphere may include a vacuum atmosphere, an atmosphere with inert gas such as nitrogen gas or argon gas, and an atmosphere in which the material derived from a plant is subjected to a kind of steaming and baking. A rate of temperature rise until the material reaches a carbonization temperature is not limited, and the example of the rate is 1° C./minute or higher, preferably 3° C./minute or higher, more preferably 5° C./minute or higher under the atmosphere described above. The upper limit of the carbonization time is, but not limited to, 10 hours, preferably 7 hours, more preferably 5 hours. As the lower limit of the carbonization time, a time in which the material derived from a plant can be surely carbonized is sufficient. The material derived from a plant may be pulverized into particles having a desired particle size or may be subjected to a classification, if desired. The material derived from a plant may be previously washed. Alternatively, the obtained porous carbon material precursor or the porous carbon material may be pulverized into particles having a desired particle size or may be subjected to a classification, if desired. Alternatively, the porous carbon material after the activation treatment may be pulverized into particles having a desired particle size or may be subjected to a classification, if desired. Further, the finally obtained porous carbon material may be subjected to sterilization. A form, a constitution or a structure of a furnace for the carbonization is not limited, and either a continuous furnace or a batch furnace may be used.

In the production method of the porous carbon material, as described above, when the activation treatment is performed, the number of micropores having smaller than 2 nm (described below) can be increased. Examples of the activation treatment may include a gas activation and a chemical activation. Here, the gas activation refers to a method in which oxygen, steam, carbonic acid gas or air is used as an activating agent, and the porous carbon material is heated under an atmosphere of the gas described above at 700° C. to 1,400° C., preferably 700° C. to 1,000° C., more preferably 800° C. to 950° C. for several tens of minutes to several hours whereby the microstructure is developed by volatile components and carbon molecules in the porous carbon material. More specifically, the heating temperature may be arbitrarily selected based on the kind of the material derived from a plant, the kind and concentration of the gas. The chemical activation refers to a method in which the activation is performed using zinc chloride, iron chloride, calcium phosphate, calcium hydroxide, magnesium carbonate, potassium carbonate or sulfuric acid instead of oxygen or steam used in the gas activation, the resulting produce is washed with hydrochloric acid, its pH is adjusted with an alkaline aqueous solution, and it is dried.

The surface of the porous carbon material in this disclosure may be subjected to a chemical treatment or molecular modification. Examples of the chemical treatment may include, for example, a treatment in which the material is treated with nitric acid to produce carboxyl groups in its surface. In addition, various functional groups such as hydroxyl groups, carboxyl groups, ketone groups and ester groups can be produced on the surface of the porous carbon material in the same manner as the activation treatment using steam, oxygen or an alkali. Further, the molecular modification can be performed by a chemical reaction with chemical species or a protein having groups capable of reacting with the porous carbon material, such as a hydroxyl group, carboxyl group or amino group.

In the production method of the porous carbon material, after the carbonization, a silicon component is removed from the material derived from a plant by treating it with an acid or alkali. Here, examples of the silicon component may include silicon oxides such as silicon dioxide, silicon oxide and salts of silicon oxide. When the silicon component in the material derived from a plant is removed after the carbonization, the porous carbon material having a high specific surface area can be obtained. In some cases, the silicon component in the material derived from a plant can be removed by a dry etching method after the carbonization.

The porous carbon material in this disclosure may include nonmetallic elements such as magnesium (Mg), potassium (K), calcium (Ca), phosphorus (P) and sulfur (S); metallic elements such as transition elements. The content of magnesium (Mg) may be, for example, 0.01% by mass or more and 3% by mass or less; the content of potassium (K) may be 0.01% by mass or more and 3% by mass or less; the content of calcium (Ca) may be 0.05% by mass or more and 3% by mass or less; the content of phosphorus (P) may be 0.01% by mass or more and 3% by mass or less; and the content of sulfur (S) may be 0.01% by mass or more and 3% by mass or less. The contents of these elements are preferably low, in terms of the increase of the specific surface area. The porous carbon material may include elements other than elements described above, and, needless to say, the contents thereof may be alternated.

Various elements in the porous carbon material in this disclosure can be analyzed by using, for example, an energy dispersive X-ray analyzer (for example, JED-2200F manufactured by JEOL) according to an energy dispersion method (EDS). In this case, the measurement may be performed, for example, in a conditions of a scanning voltage of 15 kV and an illumination current of 10 μA.

The porous carbon material in this disclosure has a lot of pores. The pores include “mesopores” having a pore size of 2 nm to 50 nm, and “micropores” having a pore size of smaller than 2 nm. The porous carbon material in this disclosure has a volume of a pore of 0.1 cm³/g or more according to the BJH method, more preferably the volume of a pore is 0.3 cm³/g or more.

The porous carbon material in this disclosure has a specific surface area according to the nitrogen BET method (hereinafter may be sometimes referred to as a “specific surface area”) of preferably 50 m²/g or more, more preferably 100 m²/g or more, further more preferably 400 m²/g or more, for obtaining further excellent functionalities.

The nitrogen BET method refers to a method in which an adsorption isotherm is obtained by adsorption and desorption of nitrogen, which is an adsorption molecule, to an adsorbing agent (the porous carbon material in this disclosure), and the measured data are analyzed based on a BET formula having the formula (1). The specific surface areas and the pore volumes can be calculated based on this method. Specifically, when the specific surface area is calculated using the nitrogen BET method, first, an adsorption isotherm is obtained by adsorption and desorption of nitrogen, which is an adsorption molecule, to the porous carbon material. Then, [p/{Vₐ(p₀−p)}] is calculated based on the formula (1) or the formula (1′) obtained by modifying the formula (1), from the obtained adsorption isotherm, and it is plotted to an equilibrium relative humidity (p/p₀). Next, a slope s (=[(C−1)/(C·Vₘ)]) and an intercept i (=[1/(C·Vₘ)]) are calculated based on a lease-squares method, regarding the obtained plots as a straight line. After that, Vm and C are calculated based on the formula (2-1) and the formula (2-2) from the obtained slope s and the intercept i. Next, a specific surface area a_{sBET} is calculated based on the formula (3) from Vₘ (see a manual of BELSORP-mini and BELSORP analysis software manufactured by Bel Japan Inc., pages 62 to 66). This nitrogen BET method is in accordance with JIS R 1626-1996 “Measuring Methods for the Specific Surface Area of Fine Ceramic Powders by Gas Adsorption Using the BET Method.”

Vₐ=(Vₘ·C·p)/[(p₀−p){1+(C−1)(p/p₀)}] (1)

[p/{Vₐ(p₀−p)}]=[(C−1)/(C·Vₘ)](p/p₀)+[1/(C·Vₘ)] (1′)

Vₘ=1/(s+i) (2-1)

C=(s/i)+1 (2-2)

a_{sBET}=(Vₘ·L·σ)/22414 (3)

In the formulae described above,

Vₐ: an adsorption amount
Vₘ: an adsorption amount of a monomolecule layer
p: a nitrogen pressure upon equilibrium
p₀: a saturation vapor pressure of nitrogen
L: an Avogadro's number
σ: an adsorption cross-sectional area of nitrogen

When the pore volume Vₚ is calculated according to the nitrogen BET method, for example, linear interpolation of the adsorption data of the adsorption isotherm obtained is performed, and an adsorption amount V is obtained under a relative pressure, which is set as a relative pressure in a pore volume calculation. The pore volume Vₚ can be calculated based on the formula (4) from this adsorption volume V (see a manual of BELSORP-mini and BELSORP analysis software manufactured by Bel Japan Inc., pages 62 to 65). Hereinafter, the pore volume according to the nitrogen BET method may be sometimes referred to as a “pore volume.”

Vₚ=(V/22414)×(M_{g}/ρ_{g}) (4)

In the formula (4),

V: an adsorption amount under a relative pressure
M_{g}: a molecular weight of nitrogen
ρ_{g}: a density of nitrogen

The pore size of the mesopore can be calculated as a distribution of pores according to the BJH method from a rate of change of pore volume to its pore size. The BJH method is widely used as a pore distribution analysis. When the pore distribution analysis is performed according to the BJH method, first, a desorption isotherm is obtained by adsorption and desorption of nitrogen, which is an adsorption molecule, to the porous carbon material. Then, when adsorption molecules are gradually desorbed from a situation in which pores are filled with the adsorption molecules (such as nitrogen), a thickness of an adsorption layer and an inner diameter (twice a core radius) of a pore generated during the desorption are obtained based on the obtained desorption isotherm, and a pore radial rₚ is calculated based on the formula (5) and a pore volume is calculated based on the formula (6). Next, a pore distribution curve can be obtained by plotting a rate of change of pore volume (dVₚ/drₚ) to the pore size (2rₚ) from the pore radial and the pore volume (see a manual of BELSORP-mini and BELSORP analysis software manufactured by Bel Japan Inc., pages 85 to 88).

rₚ=t+rₖ (5)

Vₚₙ=Rₙ·dVₙ−Rₙ·dtₙ·c·ΣZₚⱼ (6)

where

Rₙ=rₚₙ²/(rₖₙ−1+dtₙ)² (7)

In the formulae described above

rₚ: a pore radial
rₖ: a core radial (inner diameter/2) when an adsorption layer having a thickness t adsorbs to an inner wall of a pore having a pore radial rₚ under that pressure
Vₚₙ: a pore volume when the desorption of nitrogen to the wall occurs at the n-th time
dVₙ: an amount of change at that time
dtₙ: an amount of change in the thickness tₙ of the adsorption layer when the desorption of nitrogen occurs at the n-th time
rₖₙ: a core radial at that time
c: a fixed value
rₚₙ: a pore radial when the desorption of nitrogen occurs at the n-th time
Also, ΣAₚⱼ shows an integrated value of the wall areas of the pores from j=1 to j=n−1.

The pore size of the micropore can be calculated, for example, according to an MP method from a rate of change of the pore volume to its pore size as a pore distribution. When the pore distribution analysis is performed according to the MP method, first, an adsorption isotherm is obtained by adsorbing nitrogen to the porous carbon material. Then, the obtained adsorption isotherm is converted into pore volumes relative to a thickness t of the adsorption layer (t-plotted). After that, the pore distribution curve can be obtained based on curvatures of the plots (the amount of change of the pore volume relative to an amount of change of the thickness t of the adsorption layer) (see a manual of BELSORP-mini and BELSORP analysis software manufactured by Bel Japan Inc., pages 72, 73 and 82).

Alternatively, the porous carbon material may have a structure in which a peak appears within a range of 1×10⁻⁷ m to 5×10⁻⁶ m in a pore distribution according to a method of mercury penetration, and a peak appears within a range of 2 nm to 20 nm in a pore distribution according to the BJH method. In this case, the material has preferably a structure in which a peak appears within a range of 2×10⁻⁷ m to 2×10⁻⁶ m in the pore distribution according to the method of mercury penetration, and a peak appears within a range of 2 nm to 10 nm in the pore distribution according to the BJH method. The measurement of pores according to the method of mercury penetration conforms to JIS R 1655: 2003 “Test Methods for Pore Size Distribution of Formed Fine Ceramics by Method of Mercury Penetration.”

According to the nonlocal density functional theory method (NLDFT method) prescribed in JIS Z 8831-2: 2010 “Pore Size Distribution and Porosity of Powders (Solid Materials)—Part 2: Analysis of Mesopores and Micropores by Gas Adsorption,” and JIS Z 8831-3: 2010 “Pore Size Distribution and Porosity of Powders (Solid Matters)—Part 3: Analysis of Micropores by Gas Adsorption,” software attached to an automatic specific surface area/pore distribution measuring device, “BELSORP-MAX” manufactured by Bel Japan Inc., is used as analysis software. Pre-requisites in which a model is formed into a cylindrical shape, and carbon black (CB) is assumed is adopted, a distribution function of a pore distribution parameter is assumed as “no-assumption,” and the obtained analysis data are subjected to smoothing.

The porous carbon material precursor is treated with an acid or alkali. Examples of the treatment method may include, for example, a method in which the porous carbon material precursor is immersed in an aqueous solution of the acid or alkali; and a method in which the porous carbon material precursor is reacted with the acid or alkali in a gas phase. More specifically, when the precursor is treated with the acid, examples of the acid may include, for example, acidic fluorine-containing compound such as hydrogen fluoride, hydrofluoric acid, ammonium fluoride, calcium fluoride and sodium fluoride. When the fluorine-containing compound is used, the amount of fluorine atoms may be sufficient to be 4 times the amount of the silicon atoms in the silicon component included in the porous carbon material precursor, and a concentration of an aqueous solution including the fluorine-containing compound is preferably 10% by mass or more. When the silicon component (such as silicon dioxide) contained in the porous carbon material precursor is removed using hydrofluoric acid, the silicon dioxide is reacted with the hydrofluoric acid, as shown in the chemical formula (A) or the chemical formula (B) and it is removed as hexafluorosilicic acid (H₂SiF₆) or silicon tetrafluoride (SiF₄), whereby the porous carbon material can be obtained. After that, it is sufficient to wash and dry the material.

SiO₂+6HF→H₂SiF₆+2H₂O (A)

SiO₂+4HF→SiF₄+2H₂O (B)

When the material is treated with the alkali (base), examples of the alkali may include, for example, sodium hydroxide. When an aqueous solution including the alkali is used, the pH of the aqueous solution is sufficiently 11 or more. When the silicon component (such as silicon dioxide) included in the porous carbon material precursor is removed using an aqueous sodium hydroxide solution, a reaction with the silicon dioxide occurs as shown in the chemical formula (C) by heating the aqueous sodium hydroxide solution, and sodium silicate (Na₂SiO₃) is removed therefrom, whereby the porous carbon material can be obtained. When the treatment is performed by a reaction with sodium hydroxide in a gas phase, the reaction as shown in the chemical formula (C) occurs by heating sodium hydroxide in the solid state, and sodium silicate (Na₂SiO₃) is removed therefrom, whereby the porous carbon material can be obtained. After that, it is sufficient to wash and dry the material.

SiO₂+2NaOH→Na₂SiO₃+H₂O(C)

The porous carbon material in this disclosure may be for example, a porous carbon material having vacancies with a three-dimensional regularity (porous carbon material having a generally-called inverse opal structure), as disclosed in Japanese Patent Application Laid-open No. 2010-106007. Specifically, porous carbon materials having spherical vacancies three-dimensionally arranged with an average diameter of 1×10⁻⁹ m to 1×10⁻⁵ m, and a surface area of 3×10² m²/g, preferably porous carbon materials having vacancies macroscopically arranged in a configuration state corresponding to a crystal structure or having vacancies microscopically arranged in a configuration state corresponding to (111) plane orientation in a face-centered cubic structure on its surface may also be used.

The composition for oral cavity (or the porous carbon material in this disclosure) according to the first to third modes of this disclosure may be widely added to general foods, general beverages, general processed and health foods. For example, the composition can be preferably used for confectioneries (chewing gums, oral refreshing candies, tablets, taffy, candies, gum candies, chocolate, tablets, powdered juice, and the like). Examples of the dosage form (shape) capable of applying to an oral cavity of the composition for oral cavity according to the first to third modes of this disclosure may include dentifrices (toothpaste, tooth powder, liquid toothpaste) mouthwashes, mouth refreshing candies, denture cleaners, tablets for rinsing a mouth, massage cream for gums, troche, gum, yogurt, drinkable preparations, and fermentation products. The composition for oral cavity according to the first to third modes of this disclosure (or the porous carbon material in this disclosure) can be used as medicines, chemicals, anti-oxidants, or perfumery and cosmetics. The dosage form (shape) of the medicine, chemical, anti-oxidant, or perfumery and cosmetic is not particularly limited, and they can be produced adding an excipient, a disintegrator, a binding agent, a lubricant, a surfactant, alcohols, a water-soluble polymer, a sweetener, a flavor improvement, an acidifier, a carrier for drug, water, which are usually used in this field, in a well-known method according to the dosage form (shape).

The chewing gum according to the first to third modes of this disclosure may include various chewing gum components generally admixed. Specifically, the chewing gums can be produced by combining the porous carbon material according to the first to third modes of this disclosure and a gum base (for example, a natural resin, a vinyl acetate resin, a synthetic rubber, an ester gum, waxes, an emulsifier, a filler, and the like) with a mixture arbitrarily selected from palatinose, reduced palatinose (Palatinit), maltitol, glucose, sugar, reduced maltose syrup, xylitol, aspartame, a brightener, a softener, a perfume (mint perfumes such as peppermint, spearmint and menthol, fruit perfumes such as citrus, mixed fruits, a strawberry and grapes, spice perfumes such as cinnamon, clove, anethole and licorice), and a colorant. When the material is added to a powder or granules having an effect of blushing teeth, the effect of blushing teeth can be exhibited. Examples of the shape of the chewing gum according to the first to third modes of this disclosure may include a chunk, a particle, a plate, and the like. The chewing gum can be produced in the same manner as a known production method of chewing gum, except for the addition of the porous carbon material according to the first to third modes of this disclosure.

As for the oral refreshing candies (mouth refreshing candies) according to the first to third modes of this disclosure, the porous carbon material according to the first to third modes of this disclosure is combined with a mixture arbitrarily selected from candy dough obtained by boiling down a mixture, as a starting material, of sugar, a milk product, oil and fat, fruit, seed, starch, wheat flour, an acidifier and flavors, saccharides such as glucose, fructose and lactose, sugar alcohols such as reduced maltose (maltitol), xylitol, sorbitol, lactitol, Palatinit and mannitol, an emulsifier such as gum arabic, dextrin or starch, sucrose fatty acid ester as a lubricant, and the like, whereby the oral refreshing candies can be produced. Also, when the material is added to a powder or granules having an effect of blushing teeth, the effect of blushing teeth can be exhibited. Examples of the oral refreshing candy according to the first to third modes of this disclosure may include taffy, candies (which include candy dough, hard candies such as drops and blown candies, soft candies such as caramels and nougat, and a mixture of sugar and, if desired, dairy products, fat and oil, fruits, seeds, starch, wheat flour, an acidifier and flavors is used as a starting material, and it is boiled it down into a sugar-paste), tablet or tablet confectioneries (a mixture of a saccharide or reduced maltose syrup, and sugar alcohols with an emulsifier such as gum arabic and an excipient such as dextrin or starch is formed into a powder or granules, and a lubricant is added thereto to give tablets), and the like. They can be produced in the same manner as a known production method of the oral refreshing candies except for the addition of the porous carbon material according to the first to third modes of this disclosure.

### Example 1

Example 1 is directed to the composition for oral cavity, the chewing gum and the oral refreshing candy (mouth refreshing candy) according to the first to third modes of this disclosure. The composition for oral cavity, the chewing gum and the oral refreshing candies of Example 1 include a porous carbon material having a specific surface area of 10 m²/g or more according to the nitrogen BET method, and a volume of a pore of 0.1 cm³/g or more according to the BJH method. The porous carbon material is formed from a material derived from a plant including silicon as a starting material. Pores (mesopores) according to the BJH method are obtained by, at least, removing silicon atoms from the material derived from a plant having silicon atoms.

The composition for oral cavity, the chewing gum and the oral refreshing candies of Example 1 also include a porous carbon material having a specific surface area of 10 m²/g or more according to the nitrogen BET method, and a sum of volumes of pores having a diameter of 1×10⁻⁹ m to 5×10⁻⁷ m of 0.1 cm³/g or more (preferably 0.2 cm³/g or more) according to a nonlocal density functional theory method. The composition for oral cavity, the chewing gum and the oral refreshing candies of Example 1 also include porous carbon material having a specific surface area of 10 m²/g or more according to a nitrogen BET method, at least one peak within a range of 3 nm to 20 nm in a pore size distribution determined by a nonlocal density functional theory method, and a ratio of a sum of volumes of pores having a pore size in a range of 3 nm to 20 nm of 0.2 or more of a sum of volumes of all pores (specifically, the ratio is 0.479 and the sum of volumes of all pores is 1.33 cm³/g).

In Example 1, rice (rice plant) chaff was used as the material derived from a plant, which is a starting material of the porous carbon material. The porous carbon material in Example 1 is obtained by carbonization of the chaff as the starting material to convert them into the carbonaceous material (the porous carbon material precursor), and then subjecting to an acid treatment. The production method of the porous carbon material in Example 1 will be explained below.

In the production of the porous carbon material in Example 1, the material derived from a plant was carbonized at 400° C. to 1,400° C., and then the resulting product was treated with an acid or alkali to obtain a porous carbon material. That is, first, pulverized chaff (chaff of Isehikari produced in Kagoshima Prefecture, a content of silicon (Si) is 10% by mass) is subjected to heat treatment (pre-carbonization) in an inactive gas. Specifically, the chaff was heated in a nitrogen stream at 500° C. for 5 hours to carbonize it, whereby carbide was obtained. When such a treatment is performed, a tar component, which will be produced in the next carbonization can be decreased or removed. After that, 10 g of the obtained carbide was put in an alumina crucible, and the temperature therein was elevated to 800° C. at a rate of temperature rise of 5° C./minute in a nitrogen stream (10 liters/minute). When the carbonization was performed at 800° C. for one hour, the chaff was converted into a carbonaceous material (porous carbon material precursor). After that, the precursor was cooled to room temperature. The flow of the nitrogen gas was continued during the carbonization and the cooling. Next, the obtained porous carbon material precursor was subjected to an acid treatment in which the precursor was immersed in an aqueous solution including 46% by volume of hydrofluoric acid for one night, and then the resulting product was washed with water and ethyl alcohol until its pH reached 7. Subsequently, the product was dried at 120° C., and then an activation treatment in which the product was heated at 900° C. in a steam stream for 3 hours, whereby the porous carbon material in Example 1 could be obtained.

The adsorption and desorption test of nitrogen was performed using BELSORP-mini (manufactured by Bel Japan Inc.) as a measuring device for obtaining the specific surface area and pore volume. A measuring condition is that an equilibrium relative pressure (p/p₀) for measurement was set at 0.01 to 0.99. The specific surface area and pore volume were calculated using BELSORP analysis software. The nitrogen adsorption and desorption test was performed using the measuring device described above, and the pore size distributions of the mesopores and micropores were calculated according to the BJH method and the MP method using the BELSORP analysis software. The pore size of the porous carbon material was measured according to the method of mercury penetration. Specifically, the method of mercury penetration measurement was performed using a mercury porosimeter (PASCAL 440 manufactured by Thermo Electron Corporation). The range area for pores was from 10 μm to 2 nm. In addition, in the measurement according to the nonlocal density functional theory method (NLDFT method), an automatic specific surface area/pore distribution measuring device, “BELSORP-MAX” manufactured by Bel Japan Inc., was used.

pre-condition for analysis: none
pre-condition for pore shape: cylindrical shape
the number of smoothing treatments: ten times
When the measurement was performed, the sample was dried at 200° C. for 3 hours as the pre-treatment thereof.

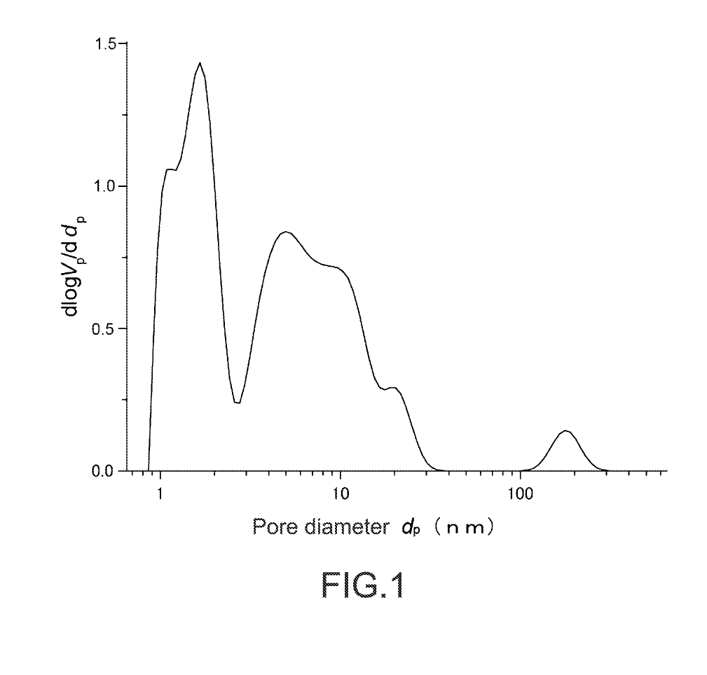

The specific surface area and pore volume of the porous carbon material in Example 1 were measured, and the results shown in Table 1 were obtained. In Table 1, the items “specific surface area” and “whole pore volume” show values of specific surface area and whole pore volume obtained by the nitrogen BET method, and units thereof are m²/g and cm³/g. In addition, the items “MP method,” “BJH method” and “method of mercury penetration” show a measurement result of a volume of pore (micropore) according to the MP method, a measurement result of a volume of pore (mesopore) according to the BJH method, and a measurement result of sum volume of pores according to the method of mercury penetration, and the units thereof are cm³/g. FIG. 1 is a graph showing measurement results of a pore size distribution of the porous carbon material in Example 1 according to the nonlocal density functional theory method.

TABLE 1

| | Specific | Whole | | | Method of |
|---|---|---|---|---|---|
| | surface | pore | MP | BJH | mercury |
| | area | volume | method | method | penetration |
| Example 1 | 1,290 | 0.87 | 0.44 | 0.70 | 2.7 |

In a prevalence test of caries bacteria, Streptococcus mutans (IFO 13955) strains were cultivated in a standard agar medium (Eiken Chemical Co., Ltd.) at 35° C.±1° C. for two days. The thus obtained test microbial strains were cultivated at 35° C.±1° C. for 18 hours to 24 hours, and they were floated in physiological salt solution to prepare test liquid of bacteria having the number of bacteria of 10⁴ to 10⁵.

The porous carbon material in Example 1 was subjected to dry sterilization at 180° C. for one hour and it was suitably weighed, to which the test liquid of bacteria was added. Hereinafter, such a test liquid of bacteria is referred to as a “test liquid.” After the test liquid was horizontally shaken (90 rmp) at room temperature, it was allowed to stand at room temperature for 60 minutes. After that, the test liquid is centrifuged (at 600 g for 5 minutes), and then supernatant liquid was immediately subjected to 10-time dilution with physiological salt solution. The number of living bacteria in the supernatant was counted using a medium for counting the number of bacteria. A test liquid of bacteria containing no porous carbon material in Example 1 was subjected to the same procedures as those for the test liquid in Example 1, and the number of living bacteria was counted using the medium for counting the number of bacteria, which results are shown as control groups. Measurement results are shown in Table 2 below. The addition amount was a mass [unit: milligram] of the porous carbon material in Example 1 added per milliliter of the test liquid of bacteria.

TABLE 2

| | Number of living bacteria |
|---|---|
| | (/milliliter) |
| Initial value | 7.9 × 10⁴ |
| Control group | 3.2 × 10⁴ |
| Addition amount: 1 mg/ml | 90 |
| Addition amount: 10 mg/ml | 60 |
| Addition amount: 50 mg/ml | 40 |

The test results show that the number of living bacteria of Streptococcus mutans in the group in which the addition amount is one milligram/milliliter or more was significantly decreased compared to the control group. The results, accordingly, showed that the porous carbon material in this disclosure had effective prevention of tooth decay.

The components of the composition for oral cavity of Example 1 are shown below.

| Components | Percent by mass |
|---|---|
| Porous carbon material | 5.0 |
| Surfactant | 1.0 |
| Wetting agent | 20.0 |
| Binder | 1.5 |
| Abrasive | 30.0 |
| Sweetener | 0.2 |
| Perfume | 1.0 |
| Base | 41.3 |

The components of the chewing gum of Example 1 are shown below.

| Components | Percent by mass |
|---|---|
| Porous carbon material | 3 |
| Gum base | 30 |
| Carbohydrate | 63 |
| Perfume | 2 |
| Softener | 2 |

The components of the oral refreshing candy (mouth refreshing candy) of Example 1 are also shown below.

| Components | Percent by mass |
|---|---|
| Porous carbon material | 0.1 |
| Sugar | 75 |
| Glucose | 20 |
| Sucrose fatty acid ester | 0.2 |
| Perfume | 0.2 |
| Water | 4.5 |

### Example 2

Example 2 is a modification of Example 1. In Example 2, SOD-like activity, which is concerned to the antioxidative effect, was measured using the porous carbon material explained in Example 1. The measurement of the SOD-like activity test was performed using an SOD activity measurement kit (manufactured by Wako Pure Chemical Industries, Ltd.). According to the SOD-like activity test, superoxide radicals, which is one kind of active oxygen species are produced from xanthine and xanthine oxidase. The produced superoxide radicals are reacted with nitroblue tetrazolium (NO₂-TB), which is a coloring reagent, to produce diformazan, whereby blue coloration occurs. If SOD-like substances are included in a reaction solution, a part of superoxide radicals are non-uniformized into H₂O₂ and O₂, thus resulting in suppression of generation of diformazan. Based on the phenomena described above, SOD-like activity can be evaluated by measuring an absorbance due to diformazan.

Specifically, first, the porous carbon material explained in Example 1 was dispersed in an addition amount of 1.0 milligram, 2.0 milligrams or 10.0 milligrams in 1 milliliter of purified water to prepare a sample solutions. To 0.1 milliliter of this sample solution were added one milliliter of a coloring reagents (xanthine and nitroblue tetrazolium), one milliliter of an enzyme solution (xanthine oxidase), and the mixture was shaken at 37° C. for 20 minutes. After that, 2 milliliter of a reaction stopping agent was added to the mixture, whereby the reaction was stopped. The sample solution after stopping the reaction was filtered through a 0.2 μm-filter, and an adsorption of filtrate was measured at a wave length of 560 nm. A case in which purified water was used instead of the sample solution is a blank; a case in which no enzyme solution was added is a control; and a case in which no porous carbon material nor enzyme solution were added is a control blank. Values of SOD-like activity were obtained from the following formula. A sample solution was prepared in the same manner as in Example 2, using medical carbon (manufactured by Nichi-Iko Pharmaceutical CO., Ltd.) in Comparative Example 2A or a edible charcoal powder (manufactured by Kabushiki Kaisha Nihon Kanpo Kenkyu-sho) in Comparative Example 2B, and the SOD-like activity test was performed in the same manner as above. The results are shown in Table 3. It was seen that the porous carbon material in Example 2 showed a sufficient SOD-like activity. As described above, because the porous carbon material in Example 2 has the high SOD-like activity, the material can be widely applied to not only the composition for oral cavity, the chewing gum and the oral refreshing candies but also antioxidants in various health processed foods, foods, beverage and medicines. Another reactive oxygen species scavenger may be used in addition to the porous carbon material of Example 2.

SOD-like activity value (%)={1−(A−B)/(C−D)}×100

In the above formula,

value A: an adsorption of the sample solution at a wave length of 560 nm
value B: an adsorption of the blank at a wave length of 560 nm
value C: an adsorption of the control at a wave length of 560 nm
value D: an adsorption of the control blank at a wave length of 560 nm

TABLE 3

| | |
|---|---|
| | SOD-like activity |
| Addition amount (mg/ml) | value (%) |

| | | |
|---|---|---|
| 1.0 | Example 2 | 34 |
| | Comparative Example 2A | 12 |
| | Comparative Example 2B | 9 |
| 2.0 | Example 2 | 48 |
| | Comparative Example 2A | 17 |
| | Comparative Example 2B | 15 |
| 10.0 | Example 2 | 98 |
| | Comparative Example 2A | 48 |
| | Comparative Example 2B | 51 |

### EXAMPLE

This disclosure has been explained based on preferable Examples as above, but this disclosure is not limited to these Examples, and various modifications can be made.

In Examples here, the chaff is used as the starting material of the porous carbon material, but other plants may be used as the starting material. Examples of the other plant may include, for example, straws, reeds, wakame stems, tracheophytes growing on land, pteridophyte, bryophyte, algae, marine plants, and the like, and they may be used alone or as a mixture of the multiple kinds thereof. Specifically, for example, straws of rice (for example, Isehikari produced in Kagoshima Prefecture) are used as the material derived from a plant, which is the starting material of the porous carbon material, the straws as the starting material is carbonized to convert into a carbonaceous material (porous carbon material precursor), and then the carbonaceous material is subjected to an acid treatment, whereby the porous carbon material can be obtained. Alternatively, a reed of Poacease is used as the material derived from a plant, which is the starting material of the porous carbon material, and the reed of Poacease, which is the starting material, is carbonized to convert into a carbonaceous material (porous carbon material precursor), and then the material is subjected to an acid treatment, whereby the porous carbon material can be obtained. The same results could be obtained from a porous carbon material obtained by a treatment using an alkali (base) such as an aqueous sodium hydroxide solution instead of the aqueous hydrofluoric acid solution

Alternatively, wakame stems (caught in Sanriku, Iwate Prefecture) are used as the material derived from a plant, which is a starting material of the porous carbon material, and the wakame steams, which are the starting material, are carbonized to convert into a carbonaceous material (porous carbon material precursor), and then the material is subjected to an acid treatment, whereby the porous carbon material can be obtained. Specifically, first, for example, the wakame stems are heated at about 500° C. to carbonize them. Prior to heating, for example, the wakame steams, which are the starting material, may be treated with an alcohol. Example of the treatment method may include in which the steams are immersed in ethyl alcohol, or the like. It is possible to decrease water included in the starting material, and also to elute elements other than carbon and mineral components included in the finally obtained porous carbon material by the treatment. In addition, the treatment with the alcohol can suppress the gas generation upon the carbonization. More specifically, the wakame stems are immersed in ethyl alcohol for 48 hours. It is preferable to perform an ultrasonicaion in ethyl alcohol. Subsequently, the wakame stems are heated in a nitrogen stream at 500° C. for 5 hours to carbonize them, whereby carbide thereof is obtained. When such a treatment (pre-carbonization treatment) is performed, a tar component, which will be produced in the next carbonization step, can be decreased or removed. After that, 10 grams of the carbide is put in an alumina crucible, it is put in a nitrogen stream (10 liters/minute), and the temperature is raised to 1,000° C. at a rate of temperature rise of 5° C./minute. The carbonization is performed at 1,000° C. for 5 hours to convert into a carbonaceous material (porous carbon material precursor), and then the product is cooled to room temperature. The flow of nitrogen gas is continued during the carbonization and the cooling. Thus, the porous carbon material can be obtained.

The present disclosure contains subject matter related to that disclosed in Japanese Priority Patent Application JP 2011-054444 filed in the Japan Patent Office on Mar. 11, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A composition for oral cavity comprising a porous carbon material having a specific surface area of 10 m²/g or more according to a nitrogen BET method, and a volume of a pore of 0.1 cm³/g or more according to a BJH method.

2. A composition for oral cavity comprising a porous carbon material having a specific surface area of 10 m²/g or more according to a nitrogen BET method, and a sum of volumes of pores having a diameter of 1×10⁻⁹ m to 5×10⁻⁷ m of 0.1 cm³/g or more according to a nonlocal density functional theory method.

3. A composition for oral cavity comprising a porous carbon material having a specific surface area of 10 m²/g or more according to a nitrogen BET method, at least one peak within a range of 3 nm to 20 nm in a pore size distribution determined by a nonlocal density functional theory method, and a ratio of a sum of volumes of pores having a pore size in a range of 3 nm to 20 nm. of 0.2 or more based on a sum of volumes of all pores.

4. A chewing gum comprising a porous carbon material having a specific surface area of 10 m²/g or more according to a nitrogen BET method, and a volume of a pore of 0.1 cm³/g or more according to a BJH method.

5. A chewing gum comprising a porous carbon material having a specific surface area of 10 m²/g or more according to a nitrogen BET method, and a sum of volumes of pores having a diameter of 1×10⁻⁹ m to 5×10⁻⁷ m of 0.1 cm³/g or more according to a nonlocal density functional theory method.

6. A chewing gum comprising a porous carbon material having a specific surface area of 10 m²/g or more according to a nitrogen BET method, at least one peak within a range of 3 nm to 20 nm in a pore size distribution determined by a nonlocal density functional theory method, and a ratio of a sum of volumes of pores having a pore size in a range of 3 nm to 20 nm of 0.2 or more based on a sum of volumes of all pores.

7. The chewing gum according to claim 4, wherein the porous carbon material has an average particle size of 1×10⁻⁷ m to 1×10⁻⁴ m.

8. The chewing gum according to claim 4, wherein the porous carbon material is included in a content of 0.01% by mass to 5% by mass.

9. An oral refreshing candy comprising a porous carbon material having a specific surface area of 10 m²/g or more according to a nitrogen BET method, and a volume of a pore of 0.1 cm³/g or more according to a BJH method.

10. An oral refreshing candy comprising a porous carbon material having a specific surface area of 10 m²/g or more according to a nitrogen BET method, and a sum of volumes of pores having a diameter of 1×10⁻⁹ m to 5×10⁻⁷ m of 0.1 cm³/g or more according to a nonlocal density functional theory method.

11. An oral refreshing candy comprising a porous carbon material having a specific surface area of 10 m²/g or more according to a nitrogen BET method, at least one peak within a range of 3 nm to 20 nm in a pore size distribution determined by a nonlocal density functional theory method, and a ratio of a sum of volumes of pores having a pore size in a range of 3 nm to 20 nm of 0.2 or more based on a sum of volumes of all pores.

12. The oral refreshing candy according to claim 9, wherein the porous carbon material has an average particle size of 1×10⁻⁷ m to 1×10⁻⁴ m.

13. The oral refreshing candy according to claim 9, wherein the porous carbon material is contained in a content of 0.01% by mass to 5% by mass.
